(19) United States
(12) Patent Application Publication
(10) Pub. No.: US 2018/0266317 A1
(43) Pub. Date: Sep. 20, 2018

(54) EVAPORATIVE COOLING MEDIUM WITH MICRO-CHANNELS

(71) Applicant: General Electric Company, Schenectady, NY (US)

(72) Inventors: Hua ZHANG, Greer, SC (US); Naveen Ghattadhahalli Parmeshwar, Greenville, SC (US); Christopher Conrad Frese, Greenville, SC (US); Valery Ivanovich Ponyavin, Greenville, SC (US); Bradly Aaron Kippel, Greer, SC (US)

(21) Appl. No.: 15/463,711

(22) Filed: Mar. 20, 2017

(51) Int. Cl. F02C 3/30; F02C 7/052

(52) U.S. Cl. CPC F02C 3/30; F02C 7/052

(57) ABSTRACT

The present application provides a gas turbine engine. The gas turbine engine may include a compressor and an inlet air system positioned upstream of the compressor. The inlet air system may include a wetted media pad for evaporative cooling. The wetted media pad may include a number of synthetic media sheets with a number of micro-channels therein.

### TECHNICAL FIELD

The present application and the resultant patent relate generally to gas turbine engines and more particularly relate to an evaporative cooling medium for a gas turbine engine having micro-channels formed therein for improved overall cooling efficiency.

### BACKGROUND OF THE INVENTION

A conventional gas turbine engine includes a compressor for compressing a flow of ambient air, a combustor for mixing the compressed flow of ambient air with a flow of fuel to create a flow of hot combustion gases, and a turbine that is driven by the hot combustion gases to produce mechanical work. The turbine may drive a load such as a generator for electrical power. Various strategies are known for increasing the amount of power that a gas turbine engine may be able to produce. One method of increasing the power output is by cooling the incoming ambient air flow upstream of the compressor. Such cooling may cause the air flow to have a higher density, thereby creating a higher mass flow rate into the compressor. The higher mass flow rate into the compressor allows more air to be compressed so as to allow the gas turbine engine to produce more power. Moreover, cooling the ambient air flow generally may increase the overall efficiency of the gas turbine engine in hot environments.

Various systems and methods may be utilized to cool the ambient air flow entering the gas turbine engine. For example, inlet air systems with one or more heat exchangers may be used to cool the ambient air flow through latent cooling or through sensible cooling. Such heat exchangers often may utilize a wetted media pad to facilitate the cooling of the ambient air flow. These wetted media pads may allow heat and/or mass transfer between the ambient air flow and a coolant flow such as a flow of water. The ambient air flow interacts with the coolant flow in the wetted media pad for heat exchange therewith. The airflow passages through such wetted media pads are intended to provide effective water evaporation and mixing of the flow of ambient air with the water vapor from the flow of water. As the air velocity increases, however, water shedding may occur. Specifically, airborne water droplets may coalesce in a downstream inlet duct and/or flow into the compressor. Such water droplets may cause blade abrasion and other types of damage.

Conversely, various types of inlet air filtration systems may be used upstream of the compressor. The incoming air flow may contain fluid particles, such as water, that may affect the performance of the gas turbine engine or other type of power generation equipment. Such fluid particles may reduce the life expectancy and performance of the gas turbine engine and other types of power generation equipment. To avoid these problems, the inlet air may pass through a series of filters and screens to assist in removing the fluid particles from the airstream. A gas turbine engine may employ both the power augmentation systems and the inlet air filtration systems.

### SUMMARY OF THE INVENTION

The present application and the resultant patent thus provide a gas turbine engine. The gas turbine engine may include a compressor and an inlet air system positioned upstream of the compressor. The inlet air system may include a wetted media pad for evaporative cooling. The wetted media pad may include a number of synthetic media sheets with a number of micro-channels therein.

The present application and the resultant patent further provide a method of cooling an inlet air flow for a gas turbine engine. The method may include the steps of positioning a synthetic media pad about an inlet of the gas turbine engine, wherein the synthetic media pad may include a number of micro-channels therein, flowing water from a top to a bottom of the synthetic media pad, flowing air through the number of micro-channels, and exchanging heat between the inlet air flow and the flow of water.

The present application and the resultant patent further provide a gas turbine engine. The gas turbine engine may include a compressor and an inlet air system positioned upstream of the compressor. The inlet air system may include a wetted media pad for evaporative cooling. The wetted media pad may include a first synthetic media sheet with a number of chevron channels, a second synthetic media sheet with a number of wavy channels, and with the first synthetic media sheet and the second synthetic media sheet including a number of micro-channels therein.

These and other features and improvements of the present application and the resultant patent will become apparent to one of ordinary skill in the art upon review of the following detailed description when taken in conjunction with the several drawings and the appended claims.

### BRIEF DESCRIPTION OF THE DRAWINGS

FIG. 1 is a schematic diagram of a gas turbine engine with a compressor, a combustor, a turbine, and a load.

FIG. 2 is a schematic diagram of an inlet air system that may be used with the gas turbine engine of FIG. 1.

FIG. 3 is a perspective view of a first side of a synthetic media pad as may be described herein.

FIG. 4 is a perspective view of a second side of the synthetic media pad of FIG. 3.

FIG. 5 is a side view of the synthetic media pad of FIG. 3.

FIG. 6 is a perspective view of a synthetic media pad with a number of micro-channels.

### DETAILED DESCRIPTION

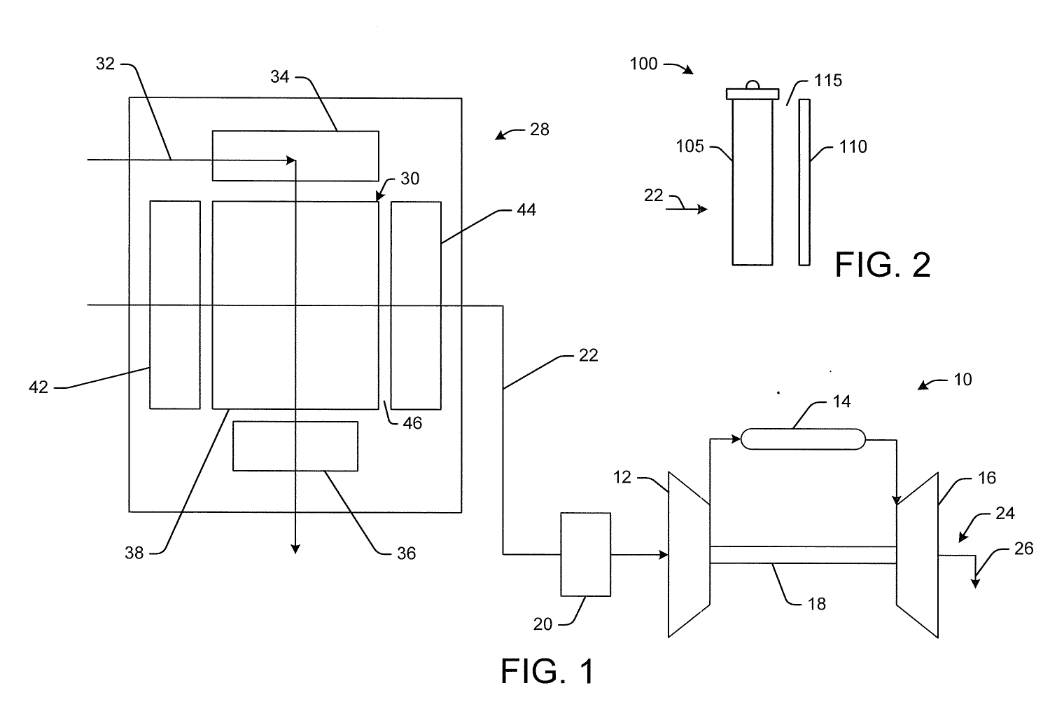

Referring now to the drawings, in which like numerals refer to like elements throughout the several views, FIG. 1 is a schematic diagram of an example of a gas turbine engine 10. The gas turbine engine 10 may include a compressor 12, a combustor 14, and a turbine 16. Although only a single combustor 14 is shown, any number of the combustors 14 may be used herein and positioned in a circumferential array and the like. The compressor 12 and the turbine 16 may be coupled by a shaft 18. The shaft 18 may be a single shaft or a number of shaft segments coupled together. The shaft 18 also may drive a load such as a generator and the like.

The gas turbine engine 10 further may include a gas turbine air inlet 20. The air inlet 20 may be configured to accept an inlet air flow 22. For example, the air inlet 20 may be in the form of a gas turbine inlet house and the like. Alternatively, the air inlet 20 may be any portion of the gas turbine engine 10, such as any portion of the compressor 12 or any apparatus upstream of the compressor 12 which may accept the inlet air flow 22. The inlet air flow 22 may be ambient air and may be conditioned or unconditioned.

The gas turbine engine 10 further may include an exhaust outlet 24. The exhaust outlet 24 may be configured to discharge a gas turbine exhaust flow 26. The exhaust flow 26 may be directed to a heat recovery steam generator (not shown). Alternatively, the exhaust flow 26 may be, for example, directed to an absorption chiller (not shown) to chill a flow of water, directed to a heat recovery steam generator (not shown), directed to a desalination plant, or dispersed into the ambient air in whole or in part.

The gas turbine engine 10 further may include an inlet air system 28 with one or more heat exchangers 30. The inlet air system 28 may be configured to cool the inlet air flow 22 before entry into the compressor 12. For example, the inlet air system 28 may be disposed about the gas turbine air inlet 20. Alternatively, the inlet air system 28 may be upstream or downstream of the gas turbine inlet 20. The inlet air system 28 may allow the inlet air flow 22 and a heat exchange medium such as a flow of water 32 to exchange heat in the heat exchanger 30. The heat exchange medium also may be any suitable type of fluid flow. The heat exchanger 30 thus may facilitate the interaction of the inlet air flow 22 and the flow of water 32 therein so as to cool the inlet air flow 22 before entering the compressor 12.

The heat exchanger 30 may be a direct contact type heat exchanger 30. The heat exchanger 30 may include a heat exchange medium inlet 34, a heat exchange medium outlet 36, and a wetted media pad 38 therebetween. The flow of water 32 or other type of heat exchange medium may flow through the heat exchange medium inlet 34 to the wetted media pad 38. The heat exchange medium inlet 34 may include a nozzle, a number of nozzles, a manifold with an orifice or a number of orifices, and the like. The heat exchange medium outlet 36 may accept the flow of water 32 exhausted from the wetted media pad 38. The heat exchange medium outlet 36 may be a sump disposed downstream of the media pad 38 in the direction of the flow of water 32. The flow of water 32 may be directed in a generally or approximately downward direction from the heat exchange medium inlet 34 through the wetted media pad 38 while the inlet air flow 22 may be directed through the heat exchanger 30 in a direction generally or approximately perpendicular to the direction of the flow of water 32. Other types of counter or cross flow arrangements also may be used.

A filter 42 may be disposed upstream of the wetted media pad 38 in the direction of inlet air flow 22. The filter 42 may be configured to remove particulates from the inlet air flow 22 so as to prevent the particulates from entering into the gas turbine engine 10. Alternatively, the filter 42 may be disposed downstream of the wetted media pad 38 in the direction of inlet air flow 22. A drift eliminator 44 may be disposed downstream of the wetted media pad 38 in the direction of inlet air flow 22. The drift eliminator 44 may act to remove droplets of the flow of water 32 from the inlet air flow 22 before the inlet air flow 22 enters the compressor 12. As described above, the drift eliminator 44 may include a number of thermoplastic components positioned at an angle downstream of the media pad 38 and the like. The angle changes the direction of the airstream to separate the water droplets therein. The wetted media pad 38 and the drift eliminator 44 may be separated by a gap 46. The length of the gap 46 may vary.

The heat exchanger 30 may be configured to cool the inlet air flow 22 through latent or evaporative cooling and convection heat transfer due to the temperature difference between the inlet air and water soaked in the media. Latent cooling refers to a method of cooling where heat is removed from a gas, such as air, so as to change the moisture content of the gas. Latent cooling may involve the evaporation of a liquid at an ambient that is higher than the wet bulb temperature to cool the gas. Specifically, latent cooling may be utilized to cool a gas to near its wet bulb temperature. Alternatively, the heat exchanger 30 may be configured to chill the inlet air flow 22 through sensible cooling, e.g., convection heat transfer. Sensible cooling refers to a method of cooling where heat is removed from a gas, such as air, so as to change the dry bulb and wet bulb temperatures of the air. Sensible cooling may involve chilling a liquid and then using the chilled liquid to cool the gas. Specifically, sensible cooling may be utilized to cool a gas to below its wet bulb temperature or dew point temperature or dew point temperature. It should be understood that latent cooling and sensible cooling are not mutually exclusive cooling methods. Rather, these methods may be occurring either exclusively or in combination. It should further be understood that the heat exchanger 30 described herein is not limited to latent cooling and sensible cooling methods, but may cool, or heat, the inlet air flow 22 through any suitable cooling or heating method as may be desired.

FIG. 2 show an example of an inlet air system 100 as may be described herein. In this example, the inlet air system 100 may include a wetted media pad 105 and a downstream drift eliminator 110. The wetted media pad 105 and the drift eliminator 110 may be separated by a gap 115. The length of the gap 115 may vary. The wetted media pad 105 and/or the drift eliminator 110 may be made out of a synthetic media pad 120 in whole or in part. The wetted media pad 105 and the drift eliminator 110 may have any suitable size, shape, or configuration. Other components and other configurations may be used herein.

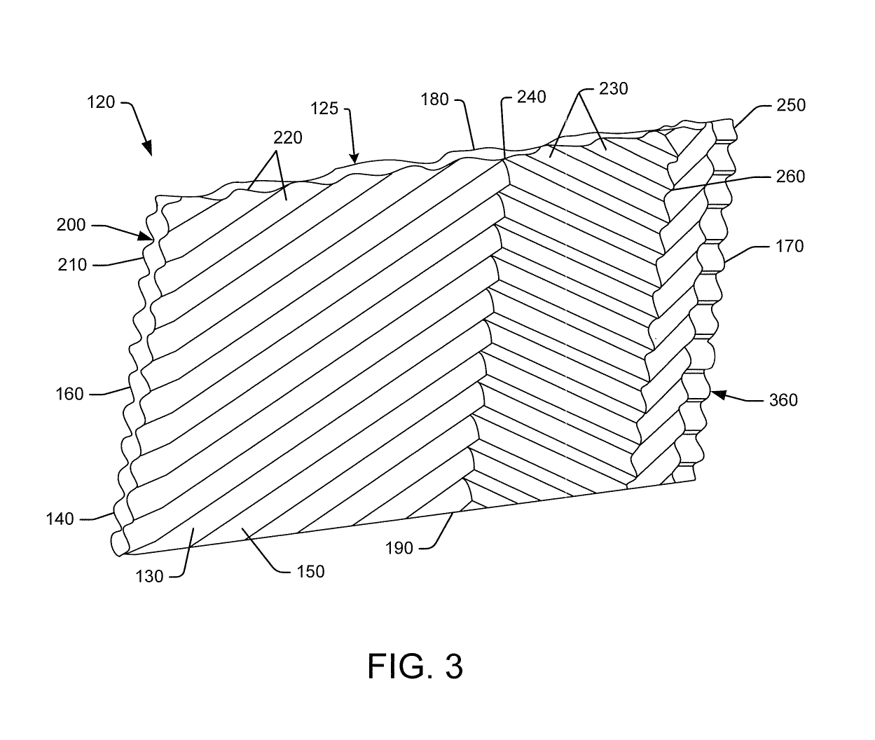

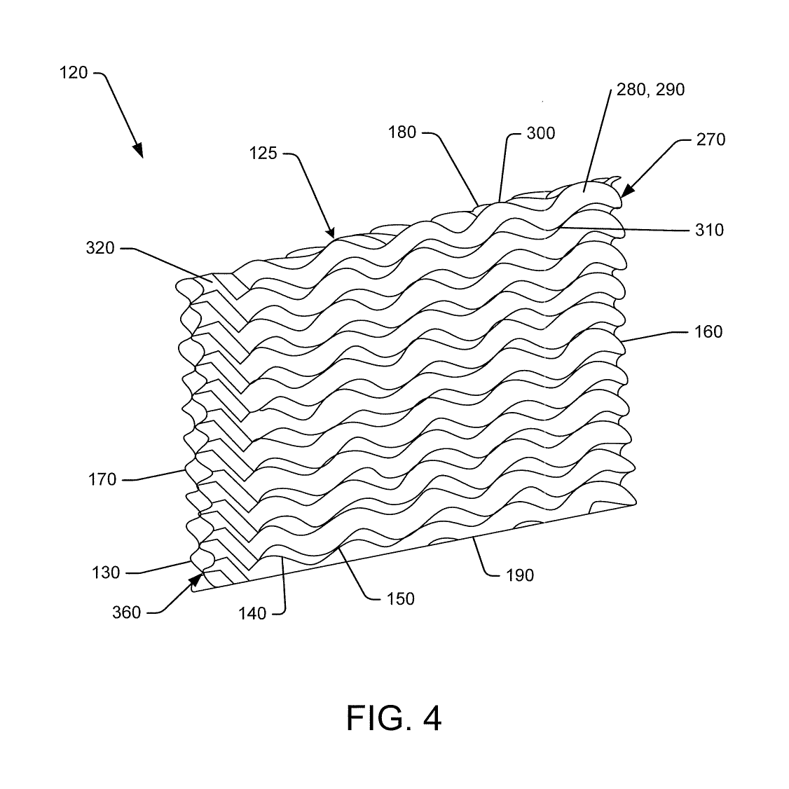

As is shown in FIGS. 3-5, the synthetic media pad 120 may include at least a pair of media sheets 125 therein. In this example, a first media sheet 130 and a second media sheet 140 are shown although additional sheets may be used herein. Any number of the media sheets 125 may be used herein in any suitable size, shape, or configuration. The media sheets 125 may be thermally formed from non-woven synthetic fibers with or without hydrophilic surface enhancements. For example, the non-woven synthetic fibers may include polyethylene terephthalate (PET), polytrimethylene terephthalate (PTT), nylon, polyester, polypropylene, and the like. The media sheets 125 may be made of plastic materials, such as polyethylene terephthalate (PET), polytrimethylene terephthalate (PTT), nylon, polyester, polypropylene, and formed using a die. Furthermore, the forming die may be of a roller type. The hydrophilic surface enhancements may include the application of a strong alkaline treatment under high processing temperatures, polyvinyl alcohol in an alkaline medium, and the like. Other materials and treatments may be used herein. The media sheets 125 may be wetable so as to accept, absorb, flow, and distribute the flow of water 32 or other type of heat exchange medium through the surface area thereof. The media sheets 125 may be utilized with different types of heat exchange mediums.

Generally described, the media sheets 125 may have a substantially three dimensional contoured shape 150. Specifically, the media sheets 125 may include a leading edge 160 facing the incoming inlet air flow 22 and a downstream trailing edge 170 facing about the compressor 12. Likewise, the media sheets 125 may have a top edge 180 for receiving the flow of water 32 and a downstream bottom edge 190 positioned about a drain and the like.

In this example, the first media sheet 130 may have a chevron like corrugated surface 200. The chevron like corrugated surface 200 may have a number of chevron channels 210 therein. Any number of the chevron channels 210 may be used herein in any suitable size, shape, or configuration. Specifically, the chevron channels 210 may have a diagonally rising portion 220 and a diagonally lowering portion 230. The diagonally rising portion 220 may extend from the leading edge 160 and meet the diagonally lowering portion 230 about an apex 240 thereof. The angle of the rising and the lowering portions may vary. Optionally, each of the chevron channels 210 may end in a first side mist eliminator portion 250. The first side mist eliminator portions 250 may extend diagonally upward in a sharp angle at a nadir 260 of each of the diagonally lowering portions 230. The first side mist eliminator portions 250 may extend from the nadir 260 towards the trailing edge 170. Other components and other configurations may be used herein.

The second media sheet 140 may have a wavy corrugated surface 270. Specifically, the wavy corrugated surface 270 may have a number of wavy channels 280. Any number of the wavy channels 280 may be used herein in any size, shape, or configuration. Specifically, the wavy channels 280 may have a substantially sinusoidal like shape 290 with a number of peaks 300 and valleys 310. Optionally, the wavy channels 280 may extend from the leading edge 160 to a second side mist eliminator portion 320. The second side mist eliminator portions 320 may extend diagonally upward in a sharp angle from one of the valleys 310 of the sinusoidal like shape 290. The second side mist eliminator portions 320 may extend from the valley 310 towards the trailing edge 170. Other components and other configurations may be used herein.

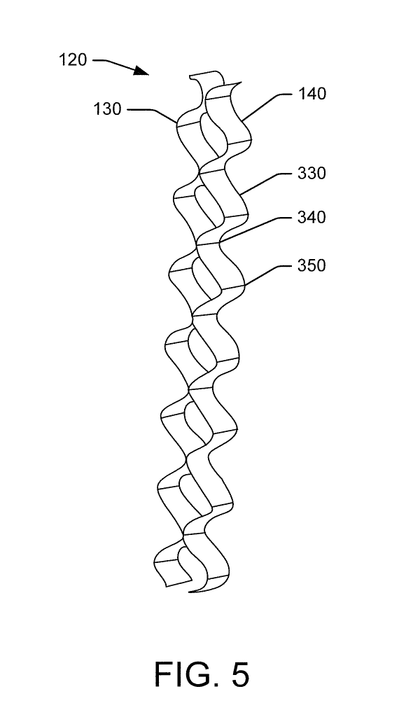

FIG. 5 shows a first media sheet 130 bound to a second media sheet 140. The leading edge 160 thus forms a diamond like shape 330. The diamond like shape 330 may include a bonding portion 340 where the media sheets 130, 140 may meet and may be bonded via glue and the like and an expanded portion 350 for good airflow therethrough. The trailing edge 170 likewise may include the diamond like shape 330 for good air flow therethrough. Optionally, the first side mist eliminator portion 250 and the second side mist eliminator portion 320 may combine to form an integrated mist eliminator 360 of a substantially uniform shape about the trailing edge 170. Other components and other configurations may be used herein.

In use, the flow of water 32 may flow from the top edge 180 to the bottom edge 190 of the media sheets 125 in the synthetic media pad 120. The media sheets 125 may be fully wetted by the flow of water 32 therethrough. The inlet air flow 22 enters via the leading edge 160 and comes in contact with the flow of water 32 for heat exchange therewith. Due to the twisting and swirling airflow generated between the media sheets 125, the flow of water 32 may evaporate into the inlet air flow 22 so as to reduce the temperature of the flow of water 32 to about the inlet air wet bulb temperature. Specifically, the twisting and swirling airflows increase heat and mass transfer therethrough.

The use of the chevron like corrugated surface 200 on the first media sheet 130 helps to distribute the flow of water 32 towards the leading edge 160. The wavy corrugated surface 270 of the second media sheet 140 provides stiffness and spreads the flow of water 32 more evenly over the media depth. The optional integrated mist eliminator 360 extends upward at a sharp angle to the airflow therethrough. This angle relies on inertial forces on any water droplets therein at the sharp turn. The water droplets thus may drain downward under the force of gravity and remain within the media sheets 125. The use of the diamond like shape 330 at the leading edge 160 and the trailing edge 170 also serves to reduce air pressure losses therethrough. The wetted media pad 105 described herein thus may increase overall air mass flow in hot weather so as to avoid or limit overall gas turbine output reduction and performance deterioration in a simplified system.

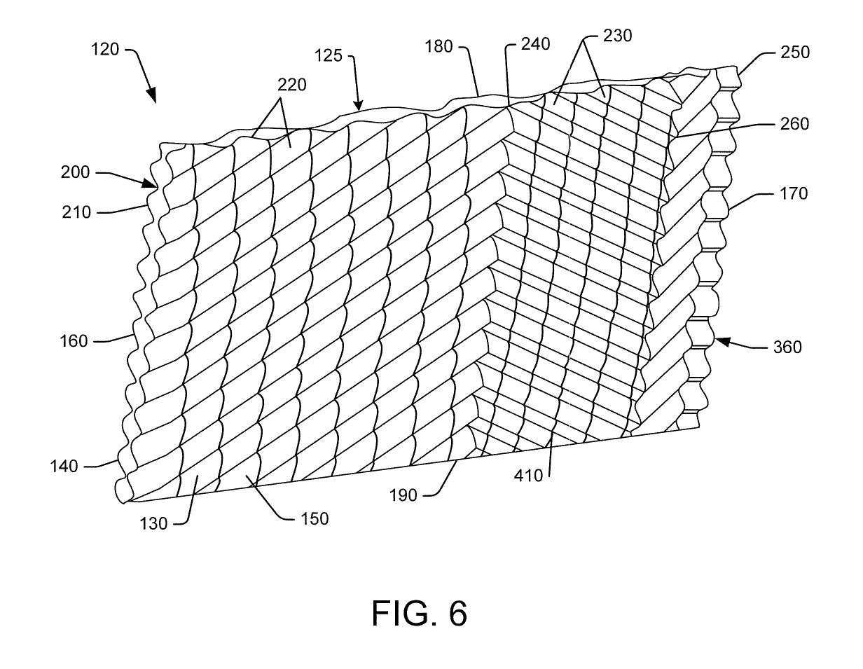

FIG. 6 shows a further embodiment a synthetic media pad 400 as may be described herein. One or both of the media sheets 220, 230 may include a number of micro-channels 410 formed therein. Any number of the micro-channels 410 may be used herein in any suitable size, shape, or configuration. By way of example, the micro-channels 410 may be formed in the plastic surface of the media sheets 220, 230 in an extrusion process with dies of small tooth. The dies may be of a roller type with small teeth to create the small micro-channels 410. The micro-channels 410 may be less than about one millimeter in width. Other types of dimensions may be used herein. Other types of manufacturing techniques may be used herein. Any number of the media sheets 220, 230 may be stacked and laminated together or otherwise joined so as to form the micro-channels 410 therebetween.

The micro-channels 410 allow water to spread to all of the surfaces that may be in contact with the inlet air given their ability to transport water with molecular force, e.g., capillary. The less wetted surface area results in more evaporative cooling. Furthermore, the evaporation in the wicked structures, i.e., the micro-channels 410 reduces the overall air temperature. The water wetting of the plastic medium is helped by capillary forces such that the evaporative cooling efficiency can be improved. The synthetic media pad 400 with the micro-channels 410 thus provides optimizes evaporative cooling with the use of less of the media material for an overall cost savings.

It should be apparent that the foregoing relates only to certain embodiments of the present application and the resultant patent. Numerous changes and modifications may be made herein by one of ordinary skill in the art without departing from the general spirit and scope of the invention as defined by the following claims and the equivalents thereof.

We claim:

1. A gas turbine engine, comprising:
a compressor; and
an inlet air system positioned upstream of the compressor;
the inlet air system comprising a wetted media pad for evaporative cooling;
wherein the wetted media pad comprises a plurality of synthetic media sheets with a plurality of micro-channels therein.

2. The gas turbine engine of claim 1, wherein the plurality of synthetic media sheets comprises polyethylene terephthalate (PET), polytrimethylene terephthalate (PTT), nylon, polyester, or polypropylene.

3. The gas turbine engine of claim 1, wherein the inlet air system comprises a flow of water in communication with the wetted media pad.

4. The gas turbine engine of claim 1, wherein the inlet air system comprises a filter and wherein the filter comprises the plurality of synthetic media sheets.

5. The gas turbine engine of claim 1, wherein the inlet air system comprises a mist eliminator and wherein the mist eliminator comprises the plurality of synthetic media sheets.

6. The gas turbine engine of claim 1, wherein the plurality of synthetic media sheets comprises:
a first media sheet;
the first media sheet comprising a chevron corrugated surface; and
a second media sheet;
the second media sheet comprising a wavy corrugated surface.

7. The gas turbine engine of claim 6, wherein the first media sheet and the second media sheet extend from a leading edge to a trailing edge.

8. The gas turbine engine of claim 7, wherein the leading edge faces the inlet air flow.

9. The gas turbine engine of claim 7, wherein the chevron corrugated surface and the wavy corrugated surface extend from the leading edge towards the trailing edge.

10. The gas turbine engine of claim 7, wherein the leading edge and the trailing edge comprise a diamond like shape.

11. The gas turbine engine of claim 10, wherein the diamond like shape comprises a bonding portion and an expanded portion.

12. The gas turbine engine of claim 6, wherein the chevron corrugated surface comprises a plurality of chevron channels with diagonally rising portions and diagonally lowering portions.

13. The gas turbine engine of claim 6, wherein the wavy corrugated surface comprises a plurality of wavy channels with peaks and valleys.

14. The gas turbine engine of claim 1, wherein the plurality of micro-channels comprises a plurality of extruded micro-channels.

15. A method of cooling an inlet air flow for a gas turbine engine, comprising:
positioning a synthetic media pad about an inlet of the gas turbine engine;
wherein the synthetic media pad comprises a plurality of micro-channels therein;
flowing water from a top to a bottom of the synthetic media pad;
flowing air through the plurality of micro-channels; and
exchanging heat between the inlet air flow and the flow of water.

16. A gas turbine engine, comprising:
a compressor; and
an inlet air system positioned upstream of the compressor;
the inlet air system comprising a wetted media pad for evaporative cooling;
wherein the wetted media pad comprises a first synthetic media sheet with a plurality of chevron channels, a second synthetic media sheet with a plurality of wavy channels, and wherein the first synthetic media sheet and the second synthetic media sheet comprise a plurality of micro-channels therein.

17. The gas turbine engine of claim 16, wherein the first synthetic media sheet and the second synthetic media sheet comprise polyethylene terephthalate (PET), polytrimethylene terephthalate (PTT), nylon, polyester, or polypropylene.

18. The gas turbine engine of claim 16, wherein the first media sheet and the second media sheet extend from a leading edge to a trailing edge and wherein the leading edge and the trailing edge comprise a diamond like shape.

19. The gas turbine engine of claim 16, wherein the plurality of chevron channels comprises diagonally rising portions and diagonally lowering portions.

20. The gas turbine engine of claim 16, wherein the plurality of wavy channels comprises peaks and valleys.
